(19) United States
(12) Patent Application Publication
(10) Pub. No.: US 2013/0346657 A1
(43) Pub. Date: Dec. 26, 2013

(54) FILE SYSTEM ON I/O DAUGHTER CARD

(71) Applicant: Vigneshwara Bhatta, Bangalore (IN)

(72) Inventor: Vigneshwara Bhatta, Bangalore (IN)

(21) Appl. No.: 13/529,030

(22) Filed: Jun. 21, 2012

(51) Int. Cl. G06F 13/20

(52) U.S. Cl. 710/107

(57) ABSTRACT

A computer system having a host processor and a storage processor. The storage processor is on a daughter I/O card. The host processor and daughter I/O care exchange file system requests and responses. The daughter I/O card responds directly to the file system requests for configuration and I/O without further processing by a block storage stack executed by the host processor. A files system client running on the host processor send file system requests directly to the daughter card via a PCIe bus. The daughter I/O card runs a file system server and includes solid state nonvolatile memory (flash) that holds a file system.

### BACKGROUND OF THE INVENTION

Mass storage systems continue to provide increased storage capacities to satisfy user demands. Photo and movie storage, and photo and movie sharing are examples of applications that fuel the growth in demand for larger and faster storage systems.

A solution to these increasing demands is the use of arrays of multiple inexpensive disks. These arrays may be configured to increase read and write performance by allowing data to be read or written simultaneously to multiple disk drives. These arrays may also be configured to allow “hot-swapping” which allows a failed disk to be replaced without interrupting the storage services of the array. Whether or not any redundancy is provided, these arrays are commonly referred to as redundant arrays of independent disks (or more commonly by the acronym RAID).

RAID storage systems typically utilize a controller that shields the user or host system from the details of managing the storage array. The controller makes the storage array appear as one or more disk drives (or volumes). This is accomplished in spite of the fact that the data (or redundant data) for a particular volume may be spread across multiple disk drives.

### SUMMARY OF THE INVENTION

An embodiment of the invention may therefore comprise a non-transitory computer readable medium having instructions stored thereon for processing I/O requests that, when executed by an I/O processor, at least instruct the I/O processor to: receive, via a PCIe bus MPT file system protocol, storage I/O requests to a file system, the storage I/O request to the file system received from a host processor without being processed by a block storage stack into block I/O device requests; and, respond to the storage I/O requests with storage I/O responses from the file system without processing into block storage stack block I/O device responses.

An embodiment of the invention may therefore further comprise a computer system, comprising: a host processor generating input/output requests to a file system; and, an input/output (I/O) processor, the I/O processor disposed on a daughter card, the I/O processor and the host processor exchanging file system requests, the I/O processor responding directly to the input/output requests to the file system without further processing by a block storage stack executing on the host processor.

An embodiment of the invention may therefore further comprise a method of processing, by a computer system including a host processor, input/output (I/O) requests to a file system, comprising: receiving, from an application, an file input/output request directed to a file stored in the file system; and, sending, without further processing by a block storage stack, a file system request based on the file input/output request to an I/O processor disposed on a daughter card; responding, by the I/O processor, to the file system request.

An embodiment of the invention may therefore further comprise a non-transitory computer readable medium having instructions stored thereon for processing I/O requests that, when executed by an I/O processor, at least instruct the I/O processor to: receive, via a PCIe bus MPT file system protocol, storage I/O requests to a file system, the storage I/O request to the file system received from a host processor without being processed by a block storage stack into block I/O device requests; and, respond to the storage I/O requests with storage I/O responses from the file system without processing into block storage stack block I/O device responses.

### BRIEF DESCRIPTION OF THE DRAWINGS

FIG. 1 is a block diagram of a computer system.

FIG. 2 is an illustration of a computer system with a file system daughter card.

FIG. 3 is an illustration of a protocol stack for providing a file system on a daughter card.

FIG. 4 is a flowchart illustrating a method of processing, by a computer system including a host processor, input/output (I/O) requests to a file system.

FIG. 5 is a flowchart illustrating a method of processing input/output (I/O) requests to a file system.

### DETAILED DESCRIPTION OF THE EMBODIMENTS

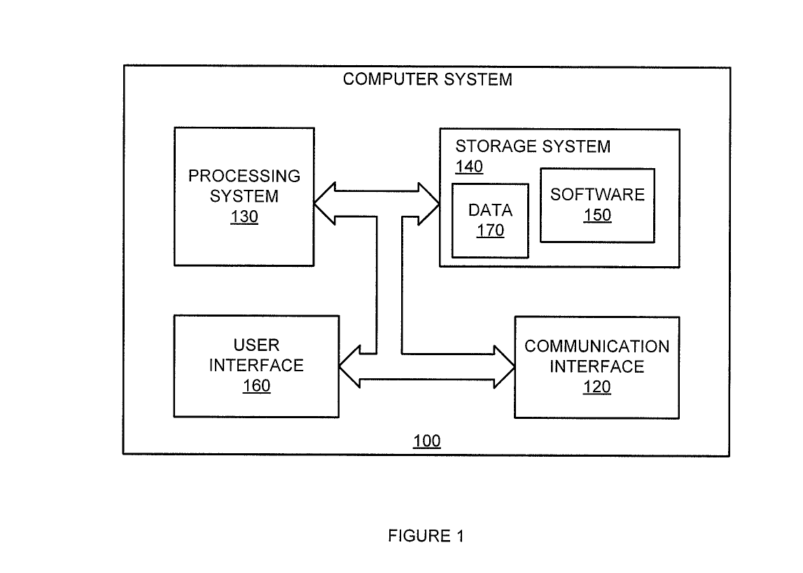

FIG. 1 is a block diagram of a computer system. Computer system 100 includes communication interface 120, processing system 130, storage system 140, and user interface 160. Processing system 130 is operatively coupled to storage system 140. Storage system 140 stores software 150 and data 170. Processing system 130 is operatively coupled to communication interface 120 and user interface 160. Computer system 100 may comprise a programmed general-purpose computer. Computer system 100 may include a microprocessor. Computer system 100 may comprise programmable or special purpose circuitry. Computer system 100 may be distributed among multiple devices, processors, storage, and/or interfaces that together comprise elements 120-170.

Communication interface 120 may comprise a network interface, modem, port, bus, link, transceiver, or other communication device. Communication interface 120 may be distributed among multiple communication devices. Processing system 130 may comprise a microprocessor, microcontroller, logic circuit, or other processing device. Processing system 130 may be distributed among multiple processing devices. User interface 160 may comprise a keyboard, mouse, voice recognition interface, microphone and speakers, graphical display, touch screen, or other type of user interface device. User interface 160 may be distributed among multiple interface devices. Storage system 140 may comprise a disk, tape, integrated circuit, RAM, ROM, EEPROM, flash memory, network storage, server, or other memory function. Storage system 140 may include computer readable medium. Storage system 140 may be distributed among multiple memory devices.

Processing system 130 retrieves and executes software 150 from storage system 140. Processing system 130 may retrieve and store data 170. Processing system 130 may also retrieve and store data via communication interface 120. Processing system 130 may create or modify software 150 or data 170 to achieve a tangible result. Processing system 130 may control communication interface 120 or user interface 160 to achieve a tangible result. Processing system 130 may retrieve and execute remotely stored software via communication interface 120.

Software 150 and remotely stored software may comprise an operating system, utilities, drivers, networking software, and other software typically executed by a computer system. Software 150 may comprise an application program, applet, firmware, or other form of machine-readable processing instructions typically executed by a computer system. When executed by processing system 130, software 150 or remotely stored software may direct computer system 100 to operate.

In an embodiment, all or part of storage system 140 may be contained on a daughter card. This daughter card may include an I/O processor disposed on the daughter card. The I/O processor and processing system 130 may exchange file system requests. The I/O processor may respond directly to these I/O requests to the file system without further processing by a block storage stack executing on processing system 130. The I/O process and processing system 130 may exchange file system requests via a PCI-express (a.k.a., PCIe or PCI-E) bus. The I/O processor and processing system 130 may exchange file system requests via the PCIe bus using MPT file system protocol.

Processing system 130 may execute a file system client that sends file system requests (without being processed by a block storage stack) to the I/O processor via the PCIe bus. The I/O processor may execute a file system server to respond to the file system requests send by the file system client executing on processing system 130. The daughter card may include solid-state nonvolatile memory. This non-volatile memory may store a file system that is accessed by the file system requests sent to the daughter card. The file system may include at least one superblock, at least one i-node, at least one d-node, and data for at least one file. The file system may include log data for storing intermediate file system metadata requests. The file server on daughter card will utilize the flash memory using a best suitable algorithm to exploit the performance of flash system and to increase the life of the flash devices. The file system may include log data for storing intermediate file system metadata requests. For better performance the non-volatile memory on daughter can be used for logging metadata.

It should be understood that in computer system 100, static(file metadata) and dynamic file data are separated, so garbage collection on Flash devices is reduced. I/O can be serialized across the Flash devices so the wear leveling (i.e., sending every I/O to different flash device) across flash devices can be achieved. This reduces write amplification. I/O data size can be tuned to work better with pages and block boundary on the flash devices. Mixed flash device types can be supported.

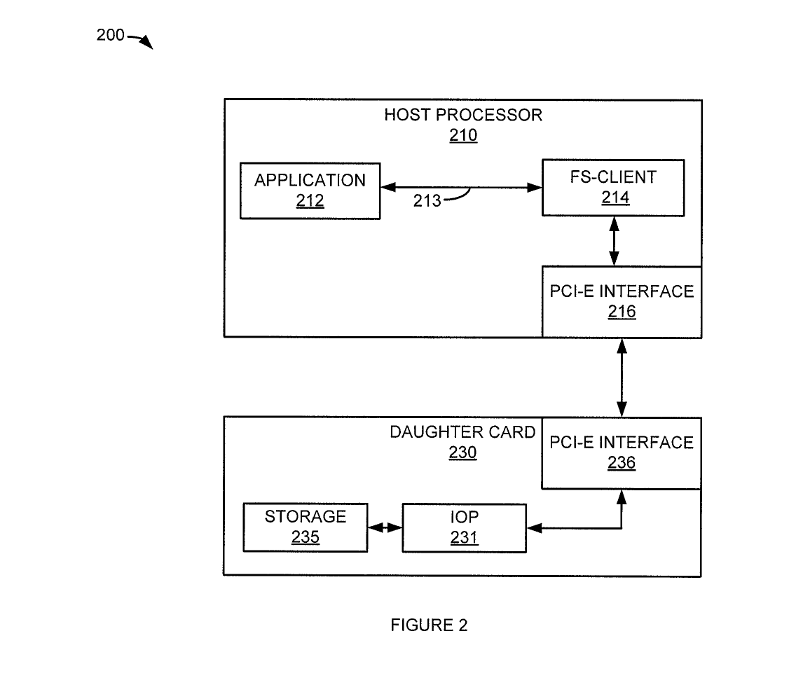

FIG. 2 is an illustration of a computer system with a file system daughter card. Computer system 200 comprises host processor 210 and daughter card 230. Computer system 200 may be considered to be a more detailed illustration of computer system 100, described previously. Host processor 210 is illustrated in FIG. 2 as including application 212, file system client (FS-client) 214, and PCI Express interface 216. Application 212 is operatively coupled to FS-client by file input/output requests 213. FS-client 214 is operatively coupled to PCI-E interface 216.

Daughter card 230 is illustrated in FIG. 2 as including storage 235, I/O processor (IOP) 231, and PCI-E interface 236. Storage 235 is operatively coupled to IOP 231. IOP 231 is operatively coupled to PCI-E interface 236. PCI-E interface 236 of daughter card 230 is operatively coupled to PCI-E interface of host processor 210. Storage 235 may include nonvolatile solid-state memory. This nonvolatile solid-state memory may store a file system. The file system stored by storage 235 may include at least one i-node, at least one d-node, and data for at least one file. This file may be accessed by application 212 using a file input/output request 213. The file system may include log data for storing intermediate file system metadata requests.

In an embodiment, application 212 may send file input/output requests 213 to FS-client 214. These file input/output requests may be directed to a file stored in a file system held on storage 235. FS-client 214 may convert file input/output requests 213 into file system requests suitable for processing by IOP 231 without processing file input/output requests into block level storage requests. Thus FS-client may send, without further processing by a block storage stack, file system requests to IOP 231 via PCI-E interface 216 and PCI-E interface 236. IOP 231 may access storage 235, and a file system stored by storage 235 in particular, to respond to those file system requests sent by FS-client 214. FS-client 214 and IOP 231 may exchange file system requests (and responses) using MPT file system protocol. In order to respond to FS-client requests, IOP 231 may execute a file system server.

To process the file system requests, daughter card may include a non-transitory computer readable medium having instructions stored thereon for processing the file system requests. These instructions may, when executed IOP 231, instruct IOP 231 to receive, via PCI-E interface 236 (and therefore via the PCI-E bus coupling PCI-E interface 231 and PCI-E interface 216), storage I/O requests (e.g., file system requests) that are received from host processor 210 without having been processed by a block storage stack into block I/O device requests. The instructions may also instruct IOP 231 to respond to these storage I/O requests (e.g., file system requests) without processing them into block storage stack type block I/O device responses.

It should be understood that FS-client 214 may cache certain things and send file system protocol frames (which are similar to network file system—NFS—frames) to daughter card 230. FS-client 214 may use MPT protocol to send these frames to daughter card 230. This avoids block level translation of the file I/O requests by block layer and kernel layer protocol stacks. Wide striping can be used to allocate every new block on a new disk. This achieves better I/O performance by using the bandwidth of all disks. This also helps to allow wear leveling on all disks. These disks may be solid-state disk (SSD) on a daughter card.

It can be seen from the foregoing, that computer system 100 and computer system 200 delegate files system related I/O to a storage daughter card (e.g., daughter card 230). This means the host processor (e.g., host processor 210) does not need to process small (i.e., word sized-32-bits or so) file I/O requests. Translating I/O requests into blocks by multiple protocol layers is reduced. Block layer and related I/O scheduling, and I/O a handling done by these layers in host processor 210 is skipped.

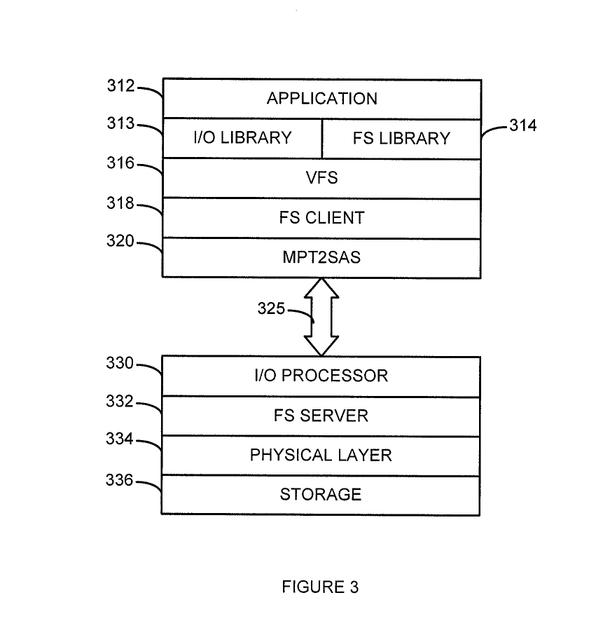

FIG. 3 is an illustration of a protocol stack for providing a file system on a daughter card. The protocol stack illustrated in FIG. 3 may be executed by computer system 100 or computer system 200. At the top of the protocol stack is application 312. The next lower layer comprises I/O library 313 and file system (FS) library 314. Application 312 may call I/O library 313 to make or receive I/O requests and/or responses. Application 312 may call FS library 314 to make or receive I/O requests to files. The next lower layer is virtual file system (VFS) 316. Below VFS 318 is FS client 318. Below FS client 318 is Message Passing Protocol (MPT) to Serial Attached SCSI (MPT2SAS) layer 320. The above layers typically execute on a host processor (e.g., host processor 210).

The MPT2SAS layer is operatively coupled to an I/O processor 330 by a PCI-E protocol bus 325. I/O processor 330 executes files system server 332. File system server 334 makes calls to a physical layer 334 in order to interface with storage 336.

The I/O flow proceeds as follows: (1) application 312 makes read/write calls to one or both of I/O library 313 and/or FS library 314; (2) I/O library 313 and/or FS library 314 passes these requests to the VFS layer 316 running at the kernel level; (3) the kernel VFS layer 316 passes the request to FS client 318. FS client 318 determines which daughter card the request is directed to. The FS client then uses a file system interface to MPT2SAS layer 320 to build and send an MPT frame holding a file system request. MPT2SAS layer 320 transfers the MPT frame via PCI-E bus 325 to I/O processor 330.

I/O processor 330 receives the MPT frame and forwards it to FS server 332. FS server 332 formats the requests into physical layer 334 requests. Physical layer 334 makes I/O requests to storage 336. Physical layer 334 may makes I/O requests to storage 336 using SATA protocol. Results (e.g., data, status, etc.) may be returned via a reverse process.

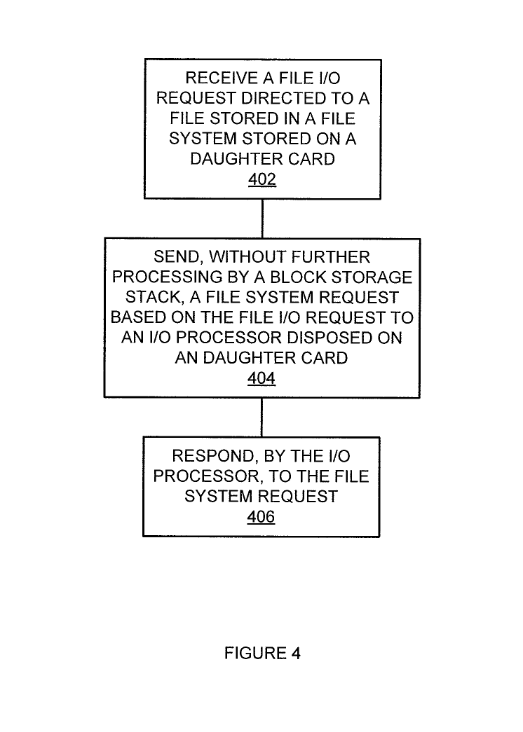

FIG. 4 is a flowchart illustrating a method of processing, by a computer system including a host processor, input/output (I/O) requests to a file system. The steps illustrated in FIG. 4 may be performed by one or more elements of computer system 100 and/or computer system 200. A file I/O request directed to a file stored in a file system stored on a daughter card is received (402). For example, FS-client 213 may receive an I/O request 213 from application 212. Without further processing by a block storage stack, a file system request that is based on the file I/O request is sent to an I/O processor disposed on a daughter card (404). For example, FS-client 213 may send a file system request, which is based on the I/O request received from application 212, to IOP 231 without first processing into block layer I/O requests. The I/O processor responds to the file system request (406). For example, IOP 231 may respond to a file system request directly without the I/O request having been processed into block device type (e.g., IOCTL) requests.

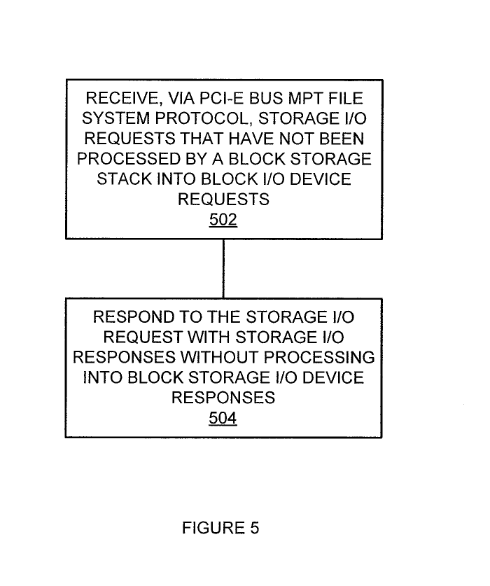

FIG. 5 is a flowchart illustrating a method of processing input/output (I/O) requests to a file system. The steps illustrated in FIG. 5 may be performed by one or more elements of computer system 100 and/or computer system 200. In particular, the steps illustrated in FIG. 5 may be performed by one or more elements of storage system 140 and/or daughter card 230. Via a PCI-E bus MPT file system protocol, storage I/O request are received that have not been processed by a block storage stack into block I/O device requests (502). For example, file system requests (not block device requests) may be received by daughter card 230 via PCI-E interface 236. These file system requests may be sent over the PCI-E bus in MPT file system protocol frames. The storage I/O requests are responded to without processing into block storage I/O device responses (504). For example, daughter card 230 may respond to the file system requests with responses that are formatted as file system responses suitable for passing by FS-client 214 to application 212 without being processed by a kernel block device driver.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A computer system, comprising:
a host processor generating input/output requests to a file system; and,
an input/output (I/O) processor, the I/O processor disposed on a daughter card, the I/O processor and the host processor exchanging file system requests, the I/O processor responding directly to the input/output requests to the file system without further processing by a block storage stack executing on the host processor.

2. The computer system of claim 1, wherein the I/O processor and the host processor exchange file system requests via a PCIe bus.

3. The computer system of claim 2, wherein the I/O processor and the host processor exchange file system requests via the PCIe bus using MPT file system protocol.

4. The computer system of claim 3, wherein the host processor executes a file system client that sends the file system requests to the I/O processor via the PCIe bus.

5. The computer system of claim 4, wherein the I/O processor executes a file system server that responds to the file system requests.

6. The computer system of claim 5, wherein the daughter card includes solid-state nonvolatile memory.

7. The computer system of claim 6, wherein the nonvolatile memory stores a file system.

8. The computer system of claim 7, wherein the file system stored in the nonvolatile memory includes at least one superblock, at least one i-node, at least one d-node, and data for at least one file.

9. The computer system of claim 8, wherein the file system includes log data for storing intermediate file system metadata requests.

10. A method of processing, by a computer system including a host processor, input/output (I/O) requests to a file system, comprising:
receiving, from an application, an file input/output request directed to a file stored in the file system;
sending, without further processing by a block storage stack, a file system request based on the file input/output request to an I/O processor disposed on a daughter card; and,
responding, by the I/O processor, to the file system request.

11. The method of claim 10, wherein the I/O processor and the host processor exchange file system requests via a PCIe bus.

12. The method of claim 11, wherein the I/O processor and the host processor exchange file system requests via the PCIe bus using MPT file system protocol.

13. The method of claim 12, wherein the host processor executes a file system client that sends the file system requests to the I/O processor via the PCIe bus.

14. The method of claim 13, wherein the I/O processor executes a file system server that responds to the file system requests.

15. The method of claim 14, wherein the daughter card includes solid-state nonvolatile memory.

16. The method of claim 15, wherein the nonvolatile memory stores a file system.

17. The method of claim 16, wherein the file system stored in the nonvolatile memory includes at least one superblock, at least one i-node, at least one d-node, and data for at least one file.

18. The method of claim 17, wherein the file system includes log data for storing intermediate file system metadata requests.

19. A non-transitory computer readable medium having instructions stored thereon for processing I/O requests that, when executed by an I/O processor, at least instruct the I/O processor to:
receive, via a PCIe bus MPT file system protocol, storage I/O requests to a file system, the storage I/O request to the file system received from a host processor without being processed by a block storage stack into block I/O device requests; and,
respond to the storage I/O requests with storage I/O responses from the file system without processing into block storage stack block I/O device responses.

20. The computer readable medium of claim 19, wherein the I/O processor is included on a daughter card comprising nonvolatile memory storing the file system.
